(19) United States
(12) Patent Application Publication
(10) Pub. No.: US 2026/0105193 A1
(43) Pub. Date: Apr. 16, 2026

(54) STORAGE MEDIUM STORING PROGRAM, CONTROL METHOD, AND INFORMATION PROCESSING APPARATUS

(71) Applicant: CANON KABUSHIKI KAISHA, Tokyo (JP)

(72) Inventor: YUSUKE MATSUI, Tokyo (JP)

(21) Appl. No.: 19/339,485

(22) Filed: Sep. 25, 2025

(30) Foreign Application Priority Data
Oct. 11, 2024 (JP) 2024-178843

(51) Int. Cl. G06F 21/64; G06F 3/12

(52) U.S. Cl. CPC G06F 21/64; G06F 3/1205; G06F 3/1225

(57) ABSTRACT

A non-transitory computer-readable storage medium storing a program for installing a printer driver having already been installed in a print server and having certificate data attached thereto, for certifying validity of a digital signature, in a client computer communicably connected to the print server. Whether or not the printer driver having already been installed in the print server is set to be sharable with the client computer is determined, and in a case where it is determined that the printer driver having been already installed in the print server is set to be sharable with the client computer, installation data including the certificate data acquired from the print server and being capable of being installed in the client computer is generated.

### BACKGROUND

### FIELD OF THE TECHNOLOGY

The present disclosure relates to a storage medium storing a program, a control method, and an information processing apparatus.

### DESCRIPTION OF THE RELATED ART

As a representative print control program that controls a printer, there is, for example, a printer driver of Windows (registered trademark). A driver set of the printer driver of Windows includes a catalog file (CAT file). To the catalog file, a digital signature can be attached to prevent alteration of the driver (see Japanese Laid-Open Patent Publication No. 2014-48956). The digital signature is data generated by encrypting a hash value of a driver (file), to which the signature is attached, with a secret key, and is capable of certifying that the driver has not been altered. Further, a certificate is attached to the digital signature. By decrypting the secret key with a public key in this certificate, it is possible to extract the hash value. Then, by comparing this hash value and a hash value of the actual catalog file, it is possible to certify validity of the catalog file, i.e. verify that the contents of each file in the driver set have not been altered.

Further, there is a case where a printer driver is installed in an information processing apparatus, such as a personal computer (PC). In this case, depending on an issuer of a digital signature attached to a catalog file, a confirmation screen for confirming whether or not to perform the installation is sometimes displayed. This confirmation screen is similarly displayed in a print server system in which, for example, a host PC connected to a printer is set as a print server, and a print instruction is given from a client PC to the printer via the print server. For example, in Point & Print (registered trademark) of Microsoft Corporation, a print server transfers a printer driver already installed in this print server to a client PC. Then, the client PC can install the printer driver transferred from the print server.

As described above, in the print server system, the confirmation screen is sometimes displayed when a driver is installed in the client PC. For example, when a driver is installed in the print server, even if installation of this driver is permitted on the confirmation screen, the confirmation screen is sometimes displayed again when the driver is installed in the client PC. Therefore, a user is required to perform the operation of permitting installation of the driver on the confirmation screen every time, and the permission operation (confirmation operation) is troublesome. That is, in spite of the fact that the driver has already been installed in the print server, and the user obviously intends to install the same driver as this driver in the client PC, the confirmation screen is redundantly displayed again.

### SUMMARY

The present disclosure is directed to providing a mechanism that makes it possible to quickly install a printer driver.

The present disclosure provides a non-transitory computer-readable storage medium storing a program for installing a printer driver having already been installed in a first information processing apparatus and having certificate data attached thereto for certifying validity of a digital signature, in a second information processing apparatus communicably connected to the first information processing apparatus, wherein the program causes a computer of the first information processing apparatus to execute a sharing determination step for determining whether or not the printer driver having already been installed is set to be sharable with the second information processing apparatus, and a data generation step for generating installation data including the certificate data acquired from the first information processing apparatus and being capable of being installed in the second information processing apparatus, in a case where it is determined in the sharing determination step that the printer driver having already been installed is set to be sharable with the second information processing apparatus.

Features of the present disclosure will become apparent from the following description of embodiments with reference to the attached drawings. The following description of embodiments are described by way of example.

### BRIEF DESCRIPTION OF THE DRAWINGS

FIG. 1 is a schematic diagram showing a whole configuration of a printing system according to a first embodiment.

FIG. 2 is a block diagram showing a hardware configuration of a print server.

FIG. 3 is a block diagram showing software configurations of the print server and a client computer.

FIG. 4 is a sequence diagram showing a process (installation process) executed between the print server and the client computer.

FIG. 5 is a diagram showing a configuration of an installation set of a printer driver.

FIGS. 6A to 6C are diagrams each showing a screen displayed in the printing system.

FIG. 7 is a diagram showing a transition state of screens displayed on a display section of the print server.

FIG. 8 is a diagram showing a screen displayed on the display section of the print server.

FIG. 9 is a flowchart of a process performed by an installer.

FIG. 10 is a diagram showing a configuration of a distributed data set distributed to the client computer.

FIG. 11 is a flowchart of a process performed by an automatic registration module.

FIG. 12 is a flowchart of a process performed by the installer according to a second embodiment.

FIG. 13 is a diagram showing a screen displayed on the display section of the print server.

FIG. 14 is a diagram showing a configuration of a packaged module distributed to the client computer.

FIG. 15 is a flowchart of a process performed by the packaged module.

FIG. 16 is a diagram showing a screen displayed on a display section of the client computer.

FIG. 17 is a flowchart of a process performed by the automatic registration module.

### DESCRIPTION OF THE EMBODIMENTS

The present disclosure will now be described in detail below with reference to the accompanying drawings showing embodiments thereof. Configurations described in the following embodiments are given only by way of example, and are by no means intended to limit the scope of the present disclosure. For example, components of each configuration of the present disclosure can be replaced with desired components which can exhibit the same functions. Further, desired components can be added. Further, two or more desired components (features) of the embodiments can be combined.

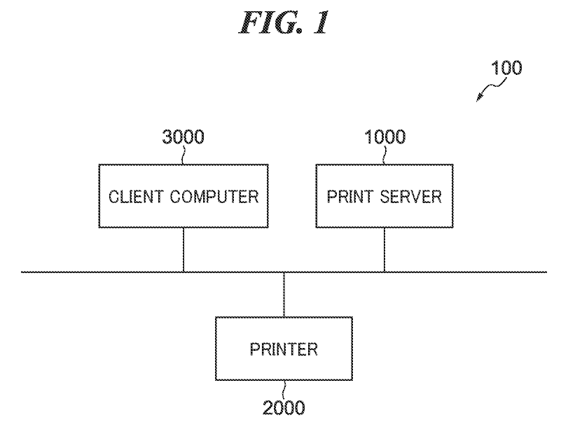

A first embodiment will be described below with reference to FIGS. 1 to 11. FIG. 1 is a schematic diagram showing a whole configuration of a printing system according to the first embodiment. As shown in FIG. 1, the printing system, denoted by reference numeral 100, includes a print server (first information processing apparatus) 1000, a printer 2000, and a client computer (second information processing apparatus) 3000, and these are communicably connected to each other. Note that the connection method is not particularly limited, but, for example, can be wired connection or wireless connection. A print instruction to the printer 2000 is sometimes given from the print server 1000 to the printer 2000 (hereinafter sometimes referred to as the “first case”). Alternatively, a print instruction is sometimes given from the client computer 3000 to the printer 2000 via the print server 1000 (hereinafter sometimes referred to as the “second case”). In both of the first and second cases, a printer driver for controlling the printer 2000 is required to have been installed in the print server 1000. Further, in the second case, the same printer driver as the printer driver already installed in the print server 1000 is also required to have been installed in the client computer 3000. This is because print data generated by an application of the client computer 3000 is required to be mediated by the printer driver on the print server 1000 before being input to the printer 2000. Note that the application is not particularly limited, but a document generation application or a spreadsheet application, for example, can be used. Further, to cause the printer driver of the print server 1000 to mediate the print data, it is necessary to cause the same printer driver to mediate the print data output from the application, on the client computer 3000.

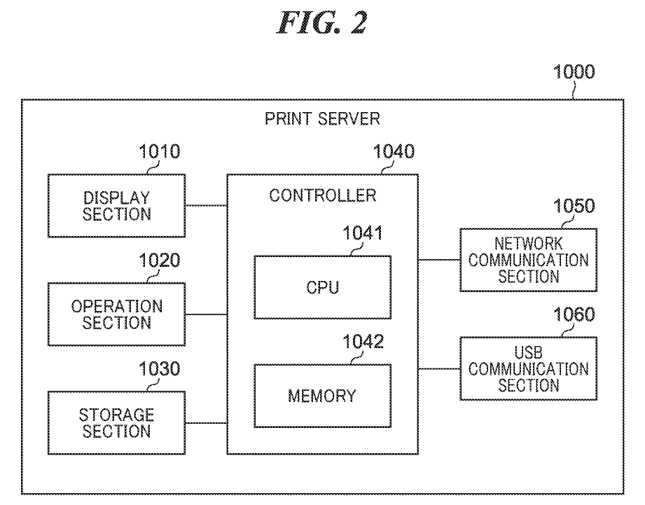

FIG. 2 is a block diagram showing a hardware configuration of the print server 1000. Note that the hardware configuration of the client computer 3000 is the same as the hardware configuration of the print server 1000. As shown in FIG. 2, the print server 1000 includes a display section 1010, an operation section 1020, a storage section 1030, a controller 1040, a network communication section 1050, and a universal serial bus (USB) communication section 1060. The controller 1040 is a computer that includes a central processing unit (CPU) 1041 and a memory 1042, and controls the overall operation of the print server 1000. The display section 1010 is formed e.g. by a liquid crystal display and displays a variety of information. The operation section 1020 includes, for example, a mouse, a keyboard, and a touch panel, and receives an instruction or the like from a user using the printing system 100. The storage section 1030 has a storage medium, such as a hard disk and a solid state drive (SSD), and stores a variety of software programs necessary for the operation of the print server 1000. Further, an operating system (OS) 1110A, a printer driver, and so forth, described hereinafter, are also stored in the storage section 1030. The network communication section 1050 is connected to a network and enables communication between the same and an external apparatus, such as the printer 2000 and the client computer 3000. The USB communication section 1060 enables communication between the same and the above-mentioned external apparatus by USB connection. The print server 1000 and the printer 2000 are connected via the network communication section 1050 or the USB connection section 1060. Note that the software processing in the present embodiment is realized by the CPU 1041 executing the software stored in the storage section 1030 and loaded into the memory 1042 of the controller 1040.

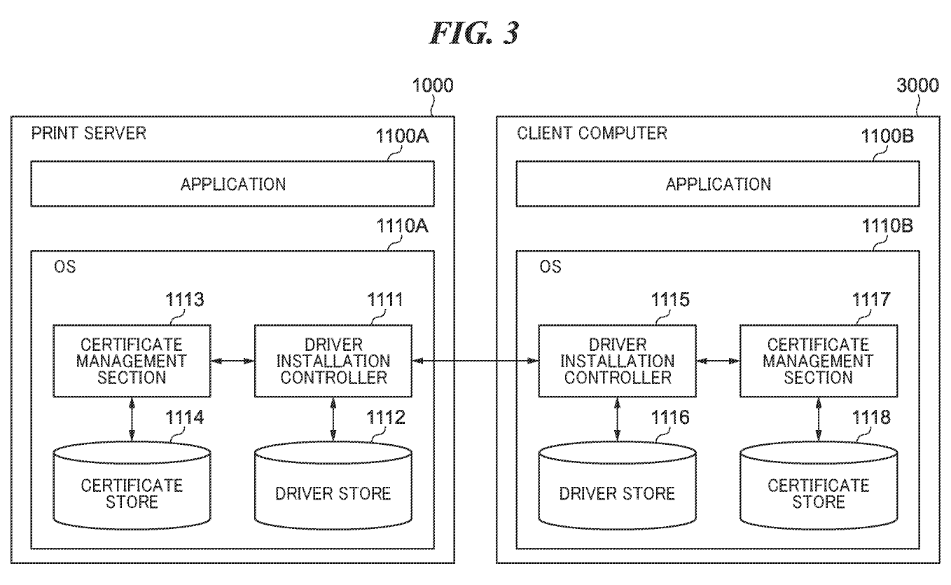

FIG. 3 is a block diagram showing software configurations of the print server and the client computer. As shown in FIG. 3, the print server 1000 has an application 1100A and the OS 1110A. These software items are stored in the storage section 1030 of the print server 1000. The application 1100A is a document generation application or a spreadsheet application, for example. Note that an installer 1210, described hereinafter, is also included in the application 1100A. The OS 1110A is software that controls basic operations of the print server 1000. The OS 1110A has a driver installation controller 1111, a driver store 1112, a certificate management section 1113, and a certificate store 1114. The driver installation controller 1111 performs control for installing a printer driver available outside the OS 1110A into the OS 1110A. Here, the printer driver is software for controlling the printer 2000 from the print server 1000. In general, this printer driver is provided from a maker that manufactures the printer 2000 or a vendor that supplies the printer 2000. Further, to install a printer driver into the OS 1110A refers to an operation of adding a printer driver provided from the maker or vendor to the OS 1110A to thereby enable the print server 1000 to use the printer 2000 under the control of the OS 1110A. The driver installation controller 1111 verifies a printer driver to be installed and stores the printer driver in the driver store 1112. In the driver store 1112, besides the printer driver, a variety of drivers for controlling peripheral devices are also stored. The certificate management section 1113 manages certificates (certificate data) registered in the OS 1110A. The certificate store 1114 stores a variety of certificates managed by the certificate management section 1113 and used by the OS 1110A. Here, the certificate refers to data that certifies validity of a digital signature. A public key is included in the certificate. By using the public key, it is possible to extract a hash value from a digital signature and certify that a printer driver (file), having the digital signature attached thereto, has not been altered. Information of the certificate is not particularly limited, but, for example, it can include an issuer of the certificate, version information of the certificate, a serial number of the certificate, the public key, and an expiration date of the certificate.

In a case where the printer 2000 is used by the client computer 3000, a printer driver which has been installed in the print server 1000 is installed in the client computer 3000 by using the mechanism of Point & Print. In Point & Print, a printer disclosed on the print server 1000 is designated from the client computer 3000, whereby the printer driver on the print server 1000 is transferred to the client computer 3000. This printer driver is processed similarly to the above-described driver installation processing on the print server 1000. This makes it also possible to use the printer 2000 on the client computer 3000 as well.

As shown in FIG. 3, the client computer 3000 has an application 1100B and an OS 1110B. These software items are stored in the storage section 1030 of the client computer 3000. Similar to the application 1100A, the application 1100B is a document generation application or a spreadsheet application, for example. The OS 1110B is software that controls the basic operation of the client computer 3000. The OS 1110B has a driver installation controller 1115, a driver store 1116, a certificate management section 1117, and a certificate store 1118. The driver installation controller 1115 performs control for installing the printer driver transferred from the print server 1000 into the OS 1110B. Further, the driver installation controller 1115 verifies this printer driver to be installed and stores the printer driver in the driver store 1116. The certificate management section 1117 stores a certificate attached to the printer driver verified by the driver installation controller 1115 in the certificate store 1118.

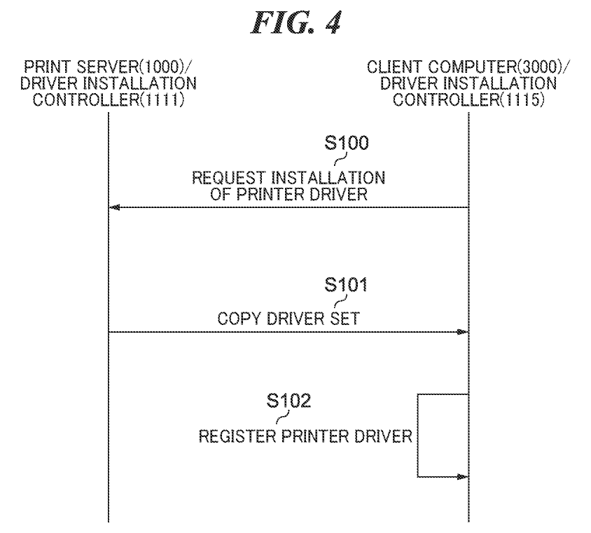

FIG. 4 is a sequence diagram showing a process (installation process) executed between the print server 1000 and the client computer 3000. Referring to FIG. 4, in a step S100, the driver installation controller 1115 of the client computer 3000 connects to a shared printer (the printer 2000 in the present embodiment) shared with the print server 1000. Then, the driver installation controller 1115 transmits a request for installing a printer driver that controls the printer 2000, to the print server 1000. At this time, the print server 1000 receives device information (including a type of the OS 1110B) concerning the client computer 3000, by Point & Print. This makes it possible for the print server 1000 to determine the operation environment of the client computer 3000.

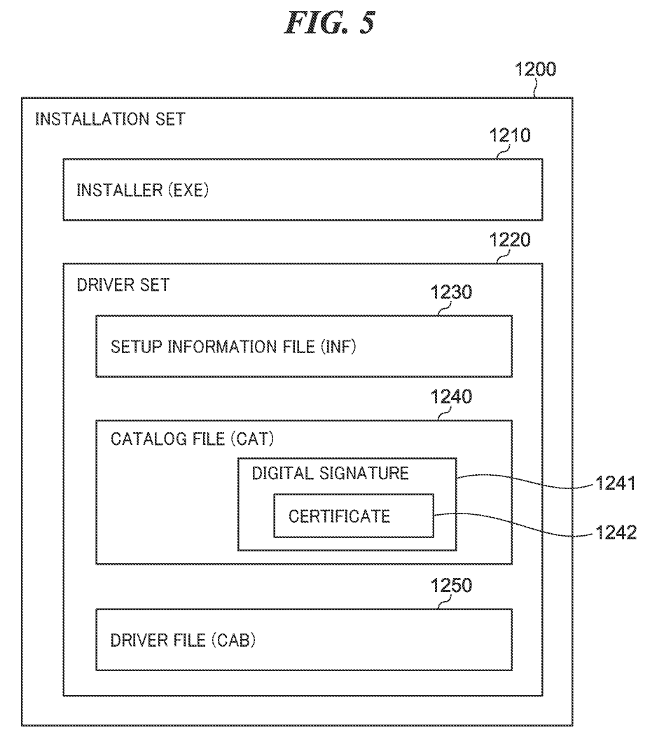

In a step S101, the driver installation controller 1111 of the print server 1000 copies an installation set 1200 (see FIG. 5) of the printer driver, which is stored in the storage section 1030 of the print server 1000, to the client computer 3000. This copy processing is executed by the driver installation controller 1111 in cooperation with the driver installation controller 1115 of the client computer 3000.

In a step S102, the driver installation controller 1115 of the client computer 3000 registers the printer driver copied in the step S101 in the OS 1110B. Then, the user can cause the printer 2000 to execute printing via the print server 1000 by operating the client computer 3000.

FIG. 5 is a diagram showing a configuration of the installation set of the printer driver. The installation set, denoted by reference numeral 1200, shown in FIG. 5 is provided from the maker or the vendor. The installation set 1200 is a file group including the installer (EXE) 1210 and a driver set 1220. The installer 1210 is a program for installing the printer driver and can cause the controller 1040 of the print server 1000 to execute steps (control method), described hereinafter. The driver set 1220 includes a setup information file (INF) 1230, a catalog file (CAT) 1240, and a driver file (CAB) 1250. The catalog file 1240 includes a digital signature 1241. The digital signature 1241 includes a certificate 1242. Note that although in the hierarchical configuration shown in FIG. 5, the certificate 1242 is included in the digital signature 1241, this is not limitative. For example, the certificate 1242 and the digital signature 1241 can be parallel in hierarchy.

A user having the authority of the administrator is allowed to perform an operation of installing the driver file 1250. The driver file 1250 is a file generated by compressing the printer driver for controlling the printer 2000, a data file, and so forth. The setup information file 1230 includes information necessary for installing the driver file 1250. This information is not particularly limited, but includes, for example, a type of the printer driver, a version of the printer driver, a file name of the catalog file 1240, a file name of the driver file 1250, and an installation destination of the driver file 1250. The catalog file 1240 is used to verify the driver set 1220 when installing the driver file 1250. The catalog file 1240 is used for determination of whether or not the driver file 1250 has been altered.

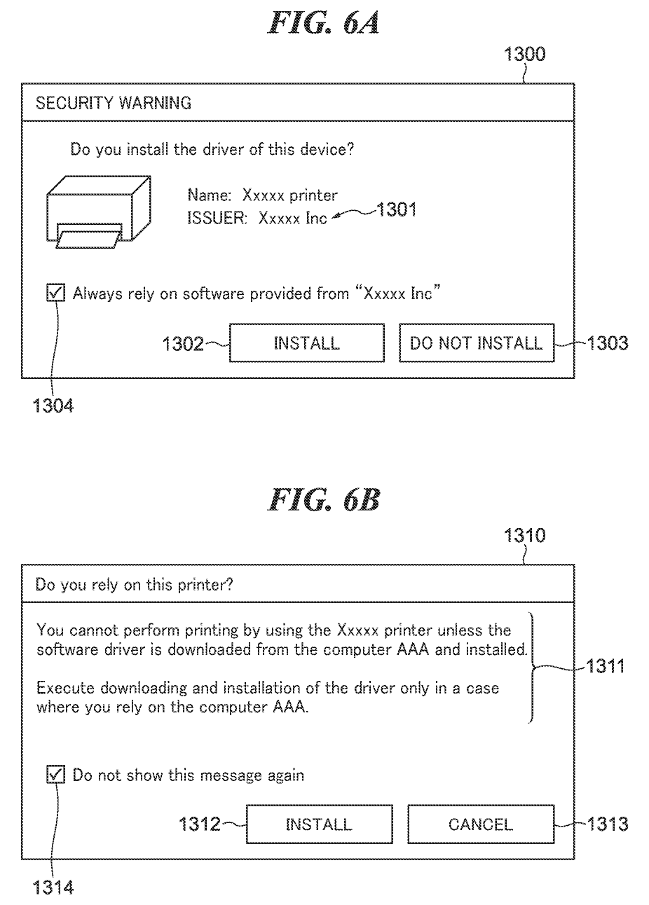

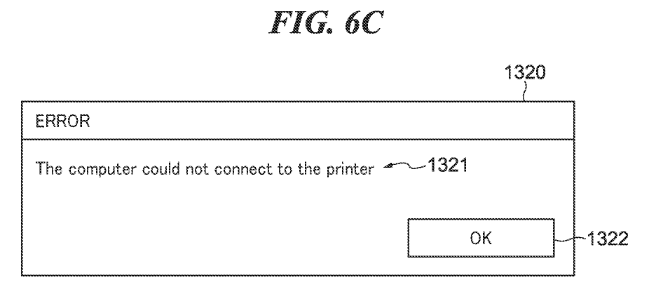

FIGS. 6A to 6C are diagrams each showing a screen displayed in the printing system. A security warning screen 1300 shown in FIG. 6A is displayed on the display section 1010 of the print server 1000. This display is performed by the OS 1110A of the print server 1000. In a case where an application programming interface (API) for driver installation is called, the OS 1110A acquires the file name of the catalog file 1240 included in the setup information file 1230. Then, the OS 1110A refers to this catalog file 1240 and identifies the certificate 1242 associated with the digital signature 1241 included in the catalog file 1240. The OS 1110A displays the security warning screen 1300 in a case where this certificate 1242 does not exist in the certificate store 1114 of the OS 1110A. The security warning screen 1300 includes issuer information 1301, a button 1302, a button 1303, and a checkbox 1304. The issuer information 1301 is information related to an issuer of the digital signature 1241 and can be e.g. a maker name or a vendor name. By pressing (operating) the button 1302, the OS 1110A starts installation of the printer driver to which the digital signature 1241 of the issuer has been attached. On the other hand, by pressing the button 1303, the OS 1110A cancels installation of the printer driver. Thus, the security warning screen 1300 can prompt a user to determine whether or not to install the printer driver. In the checkbox 1304, whether or not a user always relies on the printer driver to which the certificate 1242 of the same issuer as the digital signature 1241 has been attached is selected. In a case where the button 1302 is pressed in an ON-state in which the checkbox 1304 is checked, the OS 1110A stores (installs) the corresponding certificate 1242 in the certificate store 1114. Then, thereafter, in a case where a printer driver is to be installed to which the same certificate 1242 as the certificate 1242 stored in the certificate store 1114 has been attached, the display of the security warning screen 1300 is inhibited. On the other hand, in a case where the button 1302 is pressed in an OFF-state in which the checkbox 1304 is not checked, the OS 1110A displays the security warning screen 1300 again when the printer driver to which the same certificate 1242 has been attached is installed. By displaying the security warning screen 1300 again, it is possible to prevent installation of a printer driver signed e.g. by a suspicious issuer. Note that in the present embodiment, installation of the printer driver is executed when the button 1302 is pressed in the ON-state in which the checkbox 1304 is checked.

A security warning screen 1310 shown in FIG. 6B is displayed on the display section 1010 of the client computer 3000. The security warning screen 1310 is displayed in a case where a printer driver is installed from the print server 1000 into the client computer 3000. This display is performed by the OS 1110B of the client computer 3000. In a case where an API for driver installation is called, the OS 1110B acquires the file name of the catalog file 1240 included in the setup information file 1230 downloaded from the print server 1000. Then, the OS 1110B refers to this catalog file 1240 and identifies the certificate 1242 associated with the digital signature 1241 included in the catalog file 1240. The OS 1110B displays the security warning screen 1310 in a case where this certificate 1242 does not exist in the certificate store 1118 of the OS 1110B. The security warning screen 1310 includes a message 1311, a button 1312, a button 1313, and a checkbox 1314. The message 1311 is a message associated e.g. with a use condition of a shared printer and reliability of the print server 1000 (computer AAA). By pressing the button 1312, the OS 1110B starts installation of the printer driver. On the other hand, by pressing the button 1313, the OS 1110B cancels installation of the printer driver. Thus, similar to the security warning screen 1300, the security warning screen 1310 enables a user to determine whether or not to install the printer driver. In the checkbox 1314, whether or not to display the message 1311 after this is selected. In a case where the button 1312 is pressed in an ON-state in which the checkbox 1314 is checked, the OS 1110B stores the certificate 1242 concerned, in the certificate store 1118. Then, thereafter, in a case where a printer driver is to be installed to which the same certificate 1242 as the certificate 1242 stored in the certificate store 1118 has been attached, the display of the security warning screen 1310 is inhibited. On the other hand, in a case where the button 1312 is pressed in an OFF-state in which the checkbox 1314 is not checked, the OS 1110B displays the security warning screen 1310 again when the printer driver to which the same certificate 1242 has been attached is installed. By displaying the security warning screen 1310 again, it is possible to prevent installation of a printer driver signed e.g. by a suspicious issuer.

A security error screen 1320 shown in FIG. 6C is displayed on the display section 1010 of the client computer 3000. The security error screen 1320 is displayed in a case where a printer driver is installed from the print server 1000 into the client computer 3000. This display is performed by the OS 1110B of the client computer 3000. Similar to the case where the security warning screen 1310 is displayed, the OS 1110B displays the security error screen 1320 in a case where the certificate 1242 does not exist in the certificate store 1118 of the OS 1110B. The security error screen 1320 includes a message 1321 and a button 1322. The message 1321 is a message to the effect that connection to the shared printer was impossible. When the button 1322 is pressed, the security error screen 1320 transitions to another screen.

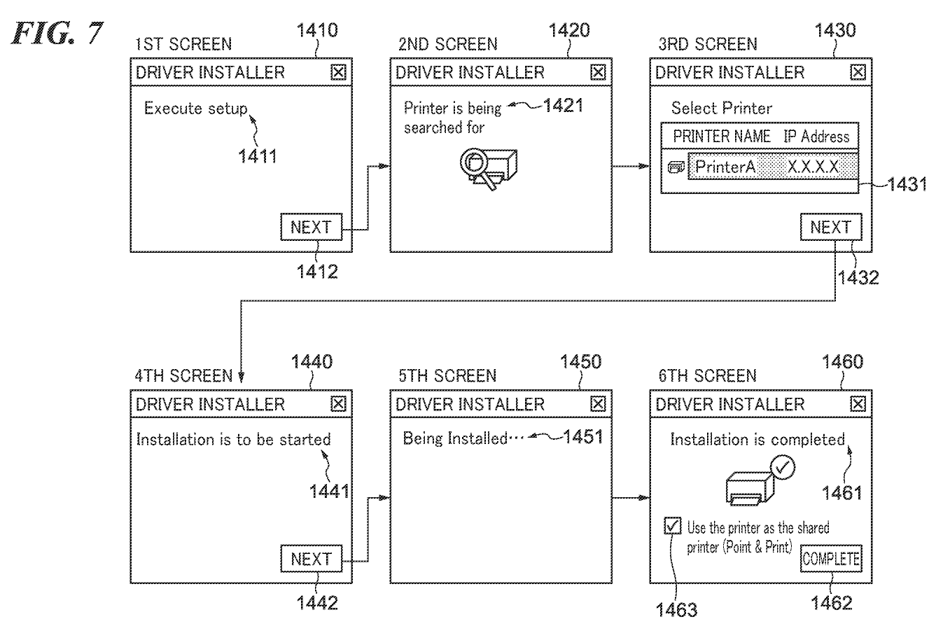

FIG. 7 is a diagram showing a transition state of screens displayed on the display section of the print server. Each screen shown in FIG. 7 is displayed by the installer 1210 of the install set 1200, i.e. displayed when the installer 1210 of the install set 1200 is executed. Further, here, a case where the installer 1210 is executed in a state in which the certificate 1242 has not been stored in the certificate store 1114 will be described. Referring to FIG. 7, on the display section 1010 of the print server 1000, a first screen 1410, a second screen 1420, a third screen 1430, a fourth screen 1440, a fifth screen 1450, and a sixth screen 1460 are sequentially displayed. The first screen 1410 is displayed when the installer 1210 is started. The first screen 1410 includes a message 1411 and a button 1412. The message 1411 is a message for prompting a user to install the printer driver. By pressing the button 1412, the second screen 1420 is displayed.

The second screen 1420 includes a message 1421. The message 1421 is a message to the effect that a printer connected to the print server 1000 and controlled by the printer driver to be installed is being searched for. In a case where the printer is detected, the third screen 1430 is displayed. The third screen 1430 includes a list 1431 and a button 1432. On the list 1431, a name and an IP address of the printer obtained by printer detection are displayed in a list. The third screen 1430 in FIG. 7 shows, by way of example, a state in which a printer having a name of “Printer A” and an IP address of “X.X.X.X” is displayed in a list, and this printer is selected. Note that it is assumed that this printer is the printer 2000. In this case, the printer driver to be installed is a printer driver that controls the printer 2000. Then, by pressing the button 1432 in a state in which the printer 2000 is selected, the fourth screen 1440 is displayed.

The fourth screen 1440 includes a message 1441 and a button 1442. The message 1441 is a message to the effect that installation of the printer driver that controls the printer 2000 is to be started. By pressing the button 1442, the fifth screen 1450 is displayed. The fifth screen 1450 includes a message 1451. The message 1451 is a message to the effect that installation of the printer driver is being executed. Installation of the printer driver is executed by the installer 1210 calling the API for driver installation, which is provided by the driver installation controller 1111 of the OS 1110A. In doing this, the installer 1210 designates the setup information file 1230 in the driver set 1220. As described above, the certificate 1242 has not been stored in the certificate store 1114. Therefore, the security warning screen 1300 is displayed. The display timing of the security warning screen 1300 can be set to a timing before the fourth screen 1440, i.e. between the third screen 1430 and the fourth screen 1440, or a timing after the fourth screen 1440, i.e. between the fourth screen 1440 and the fifth screen 1450. Then, in a case where installation of the printer driver is completed, the sixth screen 1460 is displayed.

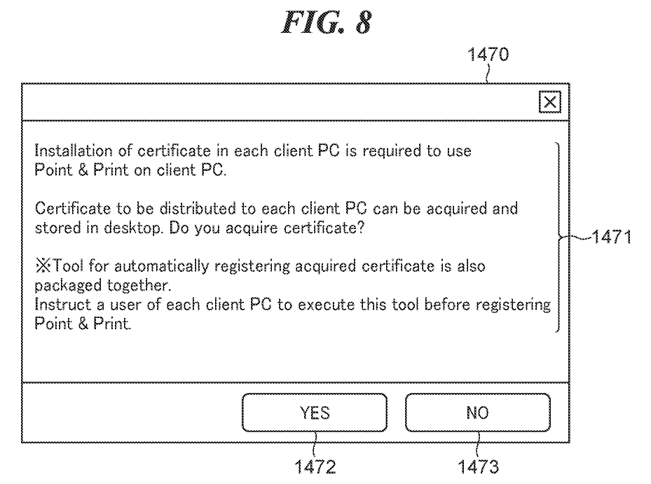

The sixth screen 1460 is a screen displayed before the determination in a sharing determination step, described hereinafter. This sixth screen 1460 is a selection screen enabling selection of whether or not to share a printer selected from the list 1431 on the third screen 1430. The sixth screen 1460 includes a message 1461, a button 1462, and a checkbox 1463. The message 1461 is a message to the effect that installation is completed. In the checkbox 1463, whether or not to use the printer selected from the list 1431 on the third screen 1430 as a shared printer is selected. In a case where the button 1462 is pressed in an ON-state in which the checkbox 1463 is checked, a seventh screen 1470 shown in FIG. 8 is displayed. The seventh screen 1470 is a screen displayed before determination in an acquisition determination step, described hereinafter. On the other hand, in a case where the button 1462 is pressed in an OFF-state in which the checkbox 1463 is not checked, the process performed by the installer 1210 is terminated without displaying the seventh screen 1470.

FIG. 8 is a diagram showing the screen displayed on the display section of the print server. The seventh screen 1470 shown in FIG. 8 is a notification screen which is displayed when a shared printer is used and notifies a user that acquisition of a certificate is required in order to use the shared printer. The seventh screen 1470 includes a message 1471, a button 1472, and a button 1473. The message 1471 is a message including requirements for using the shared printer. The message describes, as the requirements, that it is necessary to install the certificate 1242 also into the client computer 3000, in order to use the shared printer. By pressing the button 1472, the user is regarded to agree to the contents of the message 1471, whereby processing according to the contents is executed, and the seventh screen 1470 transitions to another screen. By pressing the button 1473, the user is regarded not to agree to the contents of the message 1471, whereby the seventh screen 1470 transitions to another screen. Thus, on the seventh screen 1470, whether or not to acquire the certificate 1242 can be selected according to an operation performed on the button 1472 or on the button 1473.

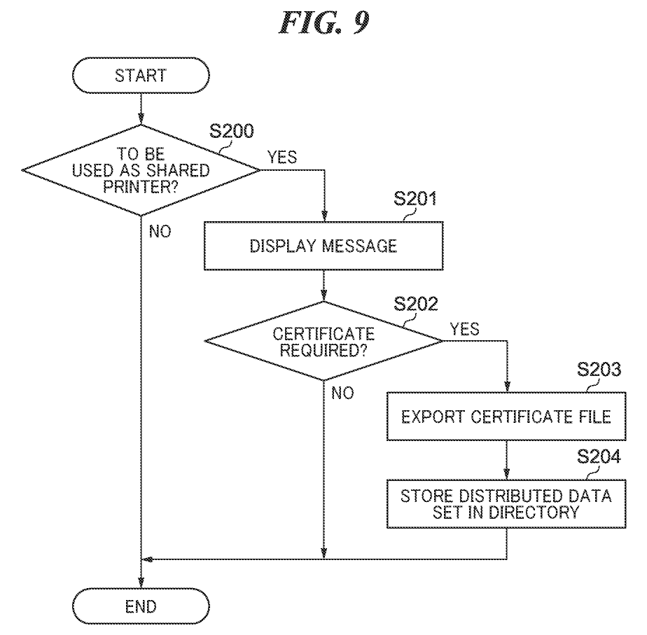

FIG. 9 is a flowchart of a process performed by the installer. Steps in the process in FIG. 9 are executed by the CPU 1041 of the print server 1000 by loading the installer 1210 stored in the storage section 1030 of the print server 1000 into the memory 1042. The program (installer 1210) of the process in FIG. 9 is started in a case where the button 1462 on the sixth screen 1460 is pressed. Referring to FIG. 9, in a step S200, the CPU 1041 (installer 1210) of the print server 1000 performs determination on the printer driver having been installed in the print server 1000 (sharing determination step). This determination determines whether or not the printer driver already installed in the print server 1000 is set to be sharable between the print server 1000 and the client computer 3000. Further, the determination is performed based on a selection state on the sixth screen 1460, i.e. whether or not the checkbox 1463 is checked. If the checkbox 1463 is checked, it is determined that the printer driver already installed in the print server 1000 is set to be sharable, and the process proceeds to a step S201. On the other hand, if the checkbox 1463 is not checked, it is determined that the printer driver already installed in the print server 1000 is not set to be sharable, followed by terminating the process. In this case, execution of a data generation step, described hereinafter, is omitted.

In the step S201, the CPU 1041 displays the seventh screen 1470 on the display section 1010 (display step).

In a step S202, the CPU 1041 determines whether or not the certificate 1242 is to be acquired by the client computer 3000, i.e. whether or not the certificate 1242 is required to be exported for the client computer 3000 (acquisition determination step). This determination is performed based on a selection state on the seventh screen 1470, i.e. an operation on the button 1472 or on the button 1473. If the button 1472 is operated, it is determined that export of the certificate 1242 is required, and the process proceeds to a step S203. On the other hand, if the button 1473 is operated, it is determined that export of the certificate 1242 is not required, and the process is terminated. In this case, execution of the data generation step is omitted.

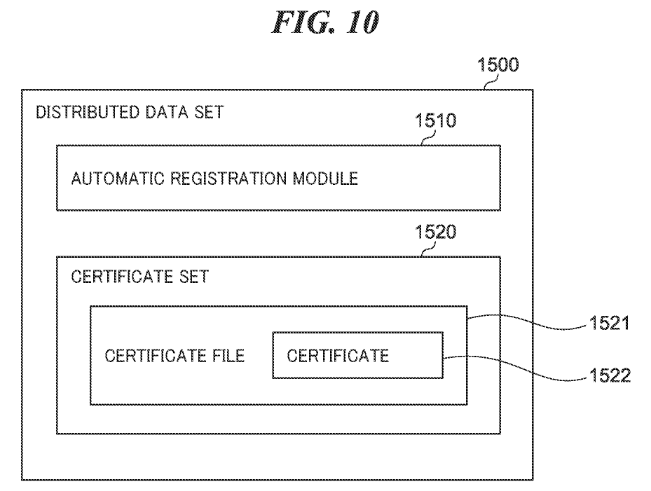

In the step S203, the CPU 1041 exports a certificate file 1521 (see FIG. 10) from the digital signature 1241. Note that although in the configuration shown in FIG. 5, one digital signature 1241 is included in the driver set 1220, this is not limitative. For example, a plurality of catalog files 1240 can be included in the driver set 1220, and one digital signature 1241 can be included in each catalog file 1240. The digital signatures 1241 are different from each other. In this case, each digital signature 1241 can be exported according to a type thereof.

In a step S204, the CPU 1041 generates a distributed data set 1500 (see FIG. 10) as installation data which can be installed in the client computer 3000 (data generation step). Further, the distribution data set 1500 is stored in a predetermined directory (such as the desktop). Note that the storage destination of the distributed data set 1500 can be a directory set in advance or a directory appropriately set by a user operation as desired. After execution of the step S204, the process is terminated.

FIG. 10 is a diagram showing a configuration of the distributed data set distributed to the client computer. The distributed data set 1500 shown in FIG. 10 is generated in the step S204 as described above. Further, the distributed data set 1500 is used by the client computer 3000 configured to use the shared printer. The distributed data set 1500 includes an automatic registration module 1510 and a certificate set 1520. The certificate set 1520 includes the certificate file 1521 exported in the step S203. The certificate file 1521 includes a certificate 1522which is the same certificate as the certificate 1242 determined to be required to be exported in the step S202. The automatic registration module 1510 is a module (such as a batch file) for installing all certificates 1522 included in the certificate set 1520 into the certificate store 1114. The certificate file 1521 is extracted from the catalog file 1240 included in the driver set 1220 of the installation set 1200. Note that although in the configuration shown in FIG. 10, one certificate file 1521 is included in the certificate set 1520, this is not limitative. For example, a plurality of certificate files 1521 can be included in the certificate set 1520. Further, the automatic registration module 1510 can be automatically generated when the distributed data set 1500 is generated or can be included in the installation set 1200 in advance.

After generation of the distributed data set 1500, the generated distributed data set 1500 is transmitted from the print server 1000 to the client computer 3000 (transmission step). Then, this distributed data set 1500 is saved, i.e. stored in the storage section 1030 of the client computer 3000 (storage step). With this, the distributed data set 1500 is placed in a state usable by the client computer 3000.

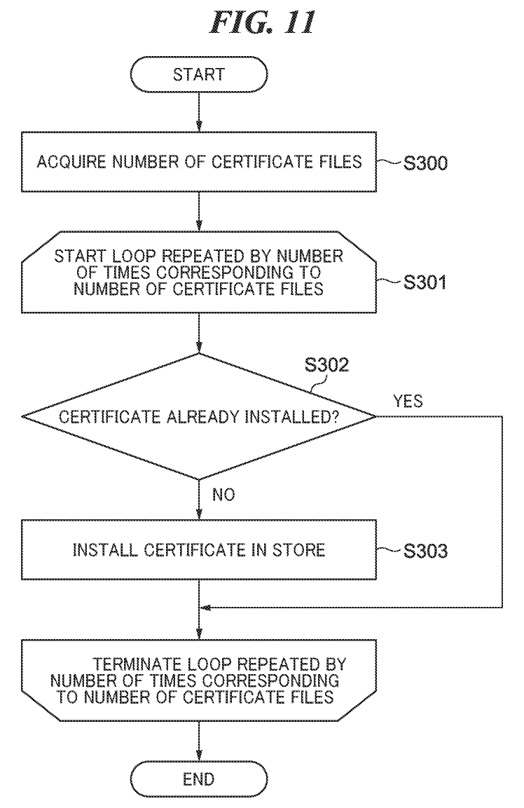

FIG. 11 is a flowchart of a process performed by the automatic registration module. Steps in the process in FIG. 11 are executed by the CPU 1041 of the client computer 3000 by loading the automatic registration module 1510 stored in the storage section 1030 of the client computer 3000 and loaded into the memory 1042. Referring to FIG. 11, in a step S300, the CPU 1041 (automatic registration module 1510) of the client computer 3000 acquires the number of certificate files 1521 included in the certificate set 1520 of the distributed data set 1500.

In a step S301, the CPU 1041 starts loop processing to be repeated by the number of times corresponding to the number of the certificate files 1521, which is acquired in the step S300.

In a step S302, the CPU 1041 sequentially loads the certificate files 1521 included in the certificate set 1520, starting from a certificate file 1521 positioned at the top. Then, the CPU 1041 determines whether or not the certificate 1522 included in the loaded certificate file 1521 has already been stored (installed) in the certificate store 1118. If it is determined in the step S302 that the certificate 1522 has already been stored, the CPU 1041 terminates the loop processing. On the other hand, if it is determined in the step S302 that the certificate 1522 has not been stored yet, the process proceeds to a step S303.

In the step S303, the CPU 1041 of the client computer 3000 stores the certificate 1522 in the certificate store 1118 (storage step). Note that the distributed data set 1500 sometimes includes a plurality of certificates 1242. In this case, the processing of storing a certificate in the certificate store 1118 is omitted with respect to the certificate 1242 which is the same as the certificate 1242 already stored in the certificate store 1118, out of the plurality of certificates 1242. This makes it possible to quickly execute the storage step.

In the printing system 100 configured as described above , it is possible to install the printer driver already installed in the print server 1000 into the client computer 3000. Further, it is possible to use the printer 2000 controlled by the printer driver, as the shared printer, on the client computer 3000 as well. Further, before installing the printer driver into the client computer 3000, i.e. before using the shared printer by the client computer 3000, the certificate 1522 is stored in the certificate store 1118. This inhibits the security warning screen 1310 (see FIG. 6B) and the security error screen 1320 (see FIG. 6C) from being displayed. With this screen display inhibition, the user can quickly install the printer driver into the client computer 3000 without hesitation. Further, compared with a configuration not using Point & print, the configuration using Point & Print can reduce the troublesome operation of additionally making a monitoring application for monitoring print data and/or the like ready for use. Further, since the monitoring application and/or the like can be omitted, the printing system 100 can have a simple configuration.

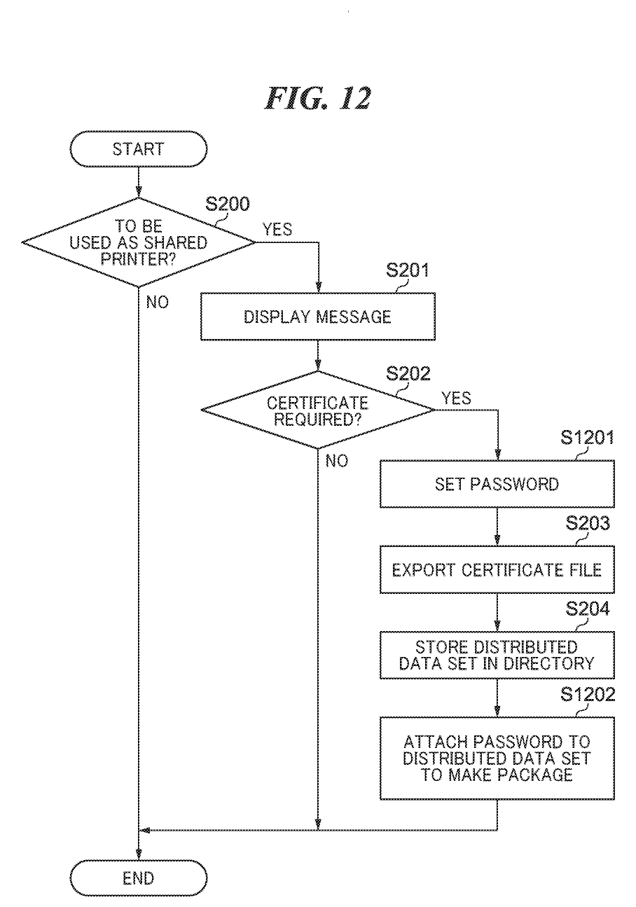

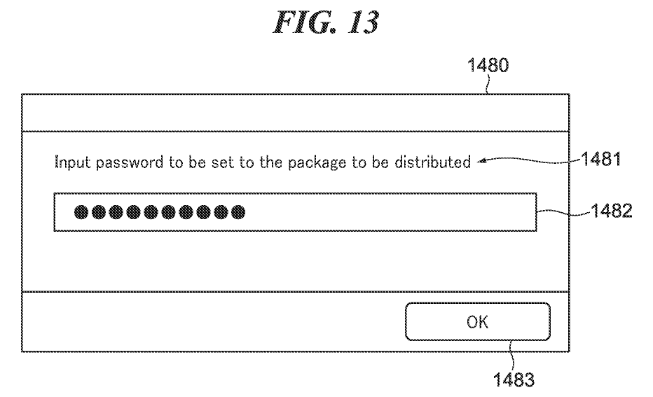

A second embodiment will be described below with reference to FIGS. 12 to 17, but the description will be given mainly of different points from the above-described embodiment, and description of the same points is omitted. FIG. 12 is a flowchart of a process performed by the installer according to the second embodiment. The process in FIG. 12 is the same as the process in FIG. 9 except that a step S1201 is executed between the steps S202 and S203, and a step S1202 is executed after the steps S204. Referring to FIG. 12, if it is determined in the step S202 that export of the certificate 1242 is required, the process proceeds to the step S1201. In the step S1201, the CPU 1041 of the print server 1000 displays a password setting screen (setting screen) 1480 (see FIG. 13) on which an operation of setting a password to the distributed data set 1500 can be performed, on the display section 1010 of the print server 1000 (display step). The password setting screen 1480 is displayed before generation of the distributed data set 1500 in the step S204. After execution of the step S1201, the process proceeds to the step S203.

Further, after execution of the step S204, the process proceeds to the step S1202. In the step S1202, the CPU 1041 attaches the password set on the password setting screen 1480 to the distributed data set 1500 generated in the step S204 and packages the distributed data set 1500 and the password. This makes it possible to ensure the security of the distributed data set 1500 and limit users who can use the distributed data set 1500. Note that when packaging the distributed data set 1500 and the password, an OS standard function, such as IExpress of Windows, can be used. After execution of the step S1202, the process is terminated.

FIG. 13 is a diagram showing the screen displayed on the display section of the print server. The password setting screen 1480 shown in FIG. 13 includes a message 1481, a password input section 1482, and a button 1483. The message 1481 is a message for prompting a user to input a password. In the password input section 1482, the user can input a desired password. By pressing the button 1483 in a state in which a password has been input in the password input section 1482, this password is stored in the storage section 1030, and the step S203 is executed. Note that although the password setting screen 1480 is a screen independent from the seventh screen 1470 in the present embodiment, this is not limitative. For example, the seventh screen can include the message 1481, the password input section 1482, and the button 1483, which are the same as those on the password setting screen 1480. Further, by setting a condition, such as a character type and the number of characters which can be input in the installer 1210, whether or not a password input in the password input section 1482 satisfies this condition can be determined. Then, if it is determined that the password does not satisfy the condition, this fact can be notified. Further, the password setting screen 1480 can be configured such that a password input in the password input section 1482 can be switched such that the password is displayable in plain text.

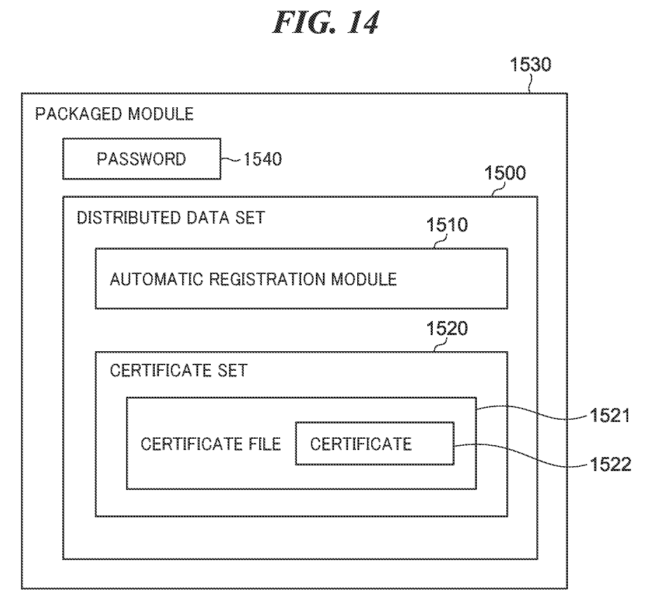

FIG. 14 is a diagram showing a configuration of the packaged module distributed to the client computer. As shown in FIG. 14, the packaged module, denoted by reference numeral 1530, includes the distributed data set 1500 and a password 1540 attached to the distributed data set 1500. The packaged module 1530 is a module formed by packaging the distributed data set 1500 and the password 1540 into one file (such as a self-extracting file). In a case where the packaged module 1530 is unpacked, the automatic registration module 1510 included in the distributed data set 1500 is executed.

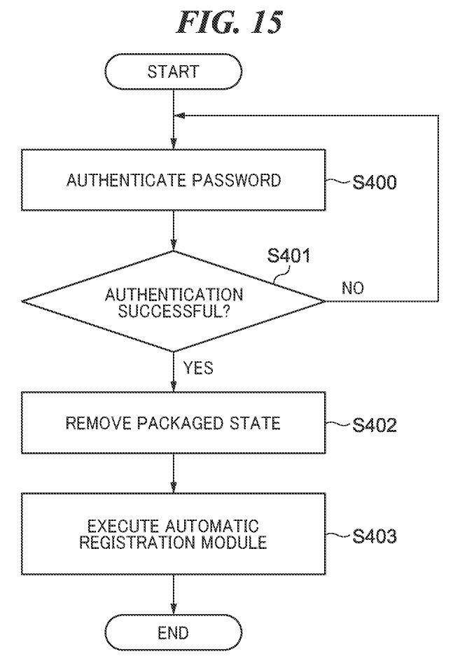

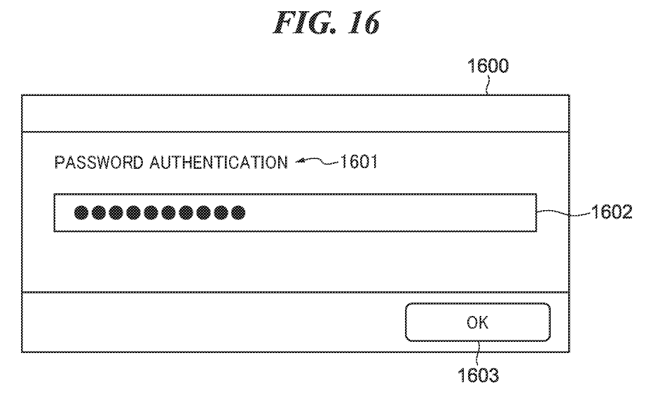

FIG. 15 is a flowchart of a process performed by the packaged module 1530. Steps in the process in FIG. 15 are executed by the CPU 1041 of the client computer 3000 by loading the packaged module 1530 stored in the storage section 1030 of the client computer 3000 into the memory 1042. As shown in FIG. 15, in a step S400, the CPU 1041 (packaged module 1530) of the client computer 3000 displays a password authentication screen 1600 (see FIG. 16) on the display section 1010.

In a step S401, the CPU 1041 determines whether or not the password input on the password authentication screen 1600 has been successfully authenticated. If it is determined in the step S401 that the password has been successfully authenticated, the process proceeds to a step S402. On the other hand, if it is determined in the step S401 that the password has not been successfully authenticated, i.e. that the password authentication has failed, the process returns to the step S401. Note that in a case where it is determined that the password authentication has failed, this fact can be notified, and a notification for prompting a user to input a password again on the password authentication screen 1600 can be performed.

In the step S402, the CPU 1041 unpacks the packaged module 1530 to extract the distributed data set 1500 from the packaged module 1530.

In a step S403, the CPU 1041 executes the automatic registration module included in the distributed data set 1500. After execution of the step S403, the process is terminated.

FIG. 16 is a diagram showing the screen displayed on the display section 1010 of the client computer 3000. The password authentication screen 1600 in FIG. 16 includes a message 1601, a password input section 1602, and a button 1603. The message 1601 prompts a user to input a password to be authenticated. In the password input section 1602, the user can input a password to be authenticated. By inputting the button 1603 in a state in which a password has been input in the password input section 1602, authentication of the password input in the password input section 1602 is performed. Then, the determination in the step S401 is performed based on a result of the authentication.

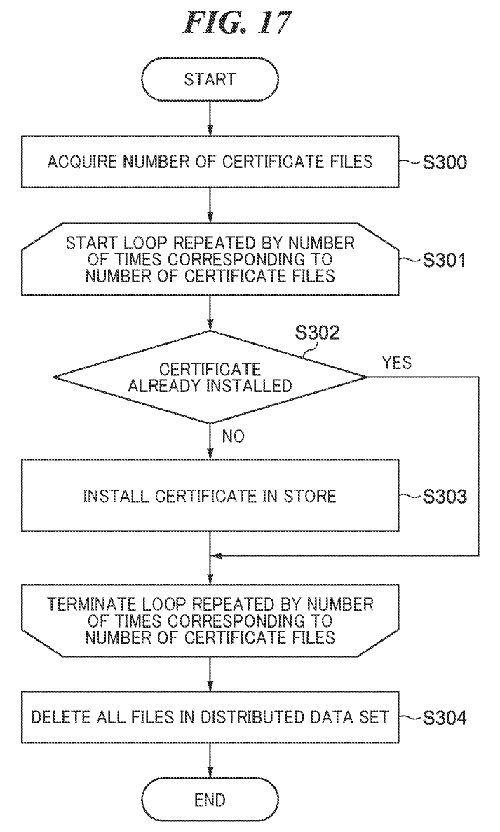

FIG. 17 is a flowchart of a process performed by the automatic registration module. The process in FIG. 17 is the same as the process in FIG. 11 except that a step S304 is executed after the step S303. Referring to FIG. 17, after the loop processing is terminated, the process proceeds to the step S304. In the step S304, the CPU 1041 (automatic registration module 1510) of the client computer 3000 deletes all files included in the distributed data set 1500. Whit this, for example, it is possible to prevent a user from extracting the certificate file 1521 and distributing the certificate file 1521 to a person other than a specific user. Note that the processing of deleting the files can be executed by a function of the OS 1110B, such as a task scheduler. After execution of the step S304, the process is terminated. Note that although in the step S303, the certificate 1522 is stored in the certificate store 1118, the password is removed at this time. With this, the certificate 1522 is smoothly stored.

According to the present disclosure, it is possible to quickly install a printer driver.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-178843, filed October 11, 2024, which is hereby incorporated by reference herein in its entirety.

What is claimed is:

1. A non-transitory computer-readable storage medium storing a program for installing a printer driver having already been installed in a first information processing apparatus and having certificate data attached thereto for certifying validity of a digital signature, in a second information processing apparatus communicably connected to the first information processing apparatus,
wherein the program causes a computer of the first information processing apparatus to execute:
a sharing determination step for determining whether or not the printer driver having already been installed is set to be sharable with the second information processing apparatus; and
a data generation step for generating installation data including the certificate data acquired from the first information processing apparatus and being capable of being installed in the second information processing apparatus, in a case where it is determined in the sharing determination step that the printer driver having already been installed is set to be sharable with the second information processing apparatus.

2. The storage medium according to claim 1, wherein the program causes the computer to execute an acquisition determination step for determining whether or not the certificate data is to be acquired by the second information processing apparatus, and
wherein in the data generation step, in a case where it is determined in the sharing determination step that the printer driver having already been installed is set to be sharable with the second information processing apparatus, and it is determined at the same time in the acquisition determination step that the certificate data is to be acquired, the installation data is generated.

3. The storage medium according to claim 1, wherein in a case where it is determined in the acquisition determination step that the certificate data is not to be acquired, the program causes the computer to omit execution of the data generation step.

4. The storage medium according to claim 2, wherein in a case where it is determined in the sharing determination step that the printer driver having already been installed is set to be sharable with the second information processing apparatus, the program causes the computer to execute a display step for displaying a notification screen for notifying that it is necessary to acquire the certificate data, before the determination in the acquisition determination step.

5. The storage medium according to claim 4, wherein the notification screen is configured such that whether or not to acquire the certificate data can be selected, and
wherein the determination in the acquisition determination step is performed based on a selection state on the notification screen.

6. The storage medium according to claim 1, wherein in a case where it is determined in the sharing determination step that the printer driver having already been installed is not set to be sharable with the second information processing apparatus, the program causes the computer to omit execution of the data generation step.

7. The storage medium according to claim 1, wherein before the determination in the sharing determination step, a selection screen is displayed for selecting whether or not to share a printer communicably connected to the first information processing apparatus and controlled by the printer driver, and
wherein the determination in the sharing determination step is performed based on a selection state on the selection screen.

8. The storage medium according to claim 1, wherein after execution of the data generation step, the program causes the computer to execute a transmission step for transmitting the installation data to the second information processing apparatus, and a storage step for storing the installation data transmitted in the transmission step in the second information processing apparatus.

9. The storage medium according to claim 8, wherein a plurality of items of the certificate data are included in the installation data, and
wherein, out of the plurality of items of the certificate data, with respect to the same item of the certificate data as an item of the certificate data, which has already been stored in the second information processing apparatus, the storage step is omitted.

10. The storage medium according to claim 1, wherein in the data generation step, when the installation data is generated, a password can be set to the installation data.

11. The storage medium according to claim 10, wherein before generating the installation data in the data generation step, the program causes the computer to execute a display step for displaying a setting screen on which an operation of setting the password is performed.

12. The storage medium according to claim 10, wherein after execution of the data generation step, the program causes the computer to execute a transmission step for transmitting the installation data to the second information processing apparatus, and a storage step for storing the installation data transmitted in the transmission step in the second information processing apparatus, and
wherein when the storage step is executed, the password is removed.

13. A control method of performing control to install a printer driver having already been installed in a first information processing apparatus and having certificate data attached thereto for certifying validity of a digital signature, in a second information processing apparatus communicably connected to the first information processing apparatus, comprising:
determining whether or not the printer driver having already been installed is set to be sharable with the second information processing apparatus; and
generating installation data including the certificate data acquired from the first information processing apparatus and being capable of being installed in the second information processing apparatus, in a case where it is determined in the determining that the printer driver having already been installed is set to be sharable with the second information processing apparatus.

14. An information processing apparatus in which a printer driver having certificate data attached thereto for certifying validity of a digital signature has been installed, including:
a program for installing, in a case where the information processing apparatus is set as a first information processing apparatus, the printer driver in a second information processing apparatus communicably connected to the first information processing apparatus, and
wherein the program causes a computer of the first information processing apparatus to execute:
a sharing determination step for determining whether or not the printer driver having already been installed is set to be sharable with the second information processing apparatus; and
a data generation step for generating installation data including the certificate data acquired from the first information processing apparatus and being capable of being installed in the second information processing apparatus, in a case where it is determined in the sharing determination step that the printer driver having already been installed is set to be sharable with the second information processing apparatus.
